(19) United States
(12) Patent Application Publication
(10) Pub. No.: US 2006/0053064 A1
(43) Pub. Date: Mar. 9, 2006

(54) Systems, methods, and media for providing photographic printing

(75) Inventors: William Bornstein, Stormville, NY (US); Anthony Cappa Spielberg, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/937,692

(22) Filed: Sep. 9, 2004

(51) Int. Cl. G06Q 30/00

(52) U.S. Cl. 705/26; 705/8

(57) ABSTRACT

Systems, methods and media for providing photographic printing are disclosed. More particularly, hardware and/or software for providing photographic printing at a photo lab to a user on a user device are disclosed. Embodiments include a method that generally includes receiving a photo file and user information from a user on a user device and determining the location of the user based on the received user information. The method may also generally include selecting a photo lab based on the determined location of the user and transmitting the photo file to a photo lab server associated with the selected photo lab. In some embodiments, the method may also generally include transmitting photographic printing information to the user, including an indication of the selected photo lab.

### FIELD OF INVENTION

The present invention is in the field of computer systems. More particularly, the present invention relates to systems, methods and media for providing photographic prints to users of digital photography equipment.

### BACKGROUND

Digital photography has quickly taken over a large and growing percentage of the photography market, displacing traditional film-based photography methods. One key aspect of the growth of digital photography is the proliferation of digital cameras. Digital cameras operate in a similar fashion to film-based media but capture and record images with a digital chip and digital media instead of film. Another aspect of digital photography involves digitizing images recorded on film using a film-based camera by scanning the film with a flatbed or film scanner. Digital photography provides many advantages over traditional photographic methods, including eliminating film processing delays and costs, ease of reviewing and deleting images, immediate feedback, etc., and thus is likely to continue to grow.

While digital photography provides many advantages to users, many users encounter problems with converting their digital images into physical prints on paper. Using traditional methods, most users simply had prints made when they had their film negatives developed. Because of the difficulties in making prints from digital images, however, many users ultimately fail to print the vast majority of their images. Many of these digital images are lost forever when hard drives crash, files are deleted, users fail to make backups, etc., without users having made prints or backups from the digital files.

Some users have begun printing their own prints from digital images at home, bypassing traditional photo labs. To do so, users often take advantage of home photographic printers, which provide high-quality prints from digital files. Printing at home, however, requires technical savvy (e.g., photo manipulation, color management, etc.), requires purchasing the appropriate photographic printing equipment, and is relatively costly because of the high cost of consumables such as ink and paper. Accordingly, many users have become frustrated with home printing or avoid home printing altogether.

On-line services for producing photographic prints are also used to provide prints to users. These services require a user to transmit a photo file, such as by file transfer protocol (ftp) or e-mail, to the on-line service for printing. The on-line service makes a print based on the photo file and then mails the print to the user. These services, while often useful, suffer from delays because of the reliance on mailing a physical object, shipping costs, and from the possibility that the print will be damaged during shipment. Moreover, larger prints are often more expensive to ship because of their size and vulnerability to damage. For many users, these delays, costs, and risks are not worth the convenience of delivery of finished prints.

More and more local photo labs have begun offering prints from digital files. These photo labs require a user to make one trip to the photo lab to deliver the digital files and to request a print and another trip to pick up their prints at a later time. Such a system is inefficient in that it require two trips by a user in order to receive their prints from digital files. Many people, especially those who live farther away from a local lab that provides this service, do not use this option because of the time and gas costs involved in making two trips to the photo lab.

There is, therefore, a need for an easy, efficient, convenient, and inexpensive system to provide photographic prints to users of digital photography equipment.

### SUMMARY OF THE INVENTION

The problems identified above are in large part addressed by systems, methods and media for providing photographic printing to a user. One embodiment provides a method for providing photographic printing that generally includes receiving a photo file and user information from a user on a user device and determining the location of the user based on the received user information. The method also generally includes selecting a photo lab based on the determined location of the user and transmitting the photo file to a photo lab server associated with the selected photo lab. In some embodiments, the method may further include modifying the photo file or archiving the photo file. In other embodiments, the method may also include transmitting photographic printing information, such as an indication of the selected photo lab, to the user.

Another embodiment provides a machine-accessible medium containing instructions effective, when executing in a data processing system, to cause the system to perform a series of operations for providing photographic printing to a user. The series of operations generally includes receiving a photo file and user information from a user on a user device and determining the location of the user based on the received user information. The series of operations also generally includes selecting a photo lab based on the determined location of the user and transmitting the photo file to a photo lab server associated with the selected photo lab. In some embodiments, the series of operations may further include modifying the photo file or archiving the photo file. In other embodiments, the series of operations may also include transmitting photographic printing information, such as an indication of the selected photo lab, to the user.

A further embodiment provides an apparatus for providing photographic printing to a user. The system may include a user interaction module for receiving a photo file and user information for the user via a network and a user location determining module for determining a location of the user based on the received user information. The system may also include a photo lab selecting module for selecting a photo lab based on the determined location of the user and a photo lab interaction module for transmitting the photo file to a photo lab server associated with the selected photo lab. A further embodiment may include a digital photo archive module for archiving a copy of the photo file or a digital photo modification module for modifying the photo file.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a photographic printing system for providing photographic prints to users on user devices according to one embodiment;

FIG. 2 depicts one embodiment of the photographic printing server of FIG. 1;

FIG. 3 depicts an example of a flow chart for receiving a photo file from a user and transmitting the photo file to a photographic printing server according to one embodiment;

FIG. 4 depicts an example of a flow chart for a receiving a request for photographic printing and printing a photograph according to one embodiment; and

FIG. 5 depicts an example of a flow chart for transmitting a photo file for printing according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for providing photographic printing are disclosed. More particularly, hardware and/or software for providing photographic printing at a photo lab to a user on a user device are disclosed. Embodiments include a method that generally includes receiving a photo file and user information from a user on a user device and determining the location of the user based on the received user information. The method may also generally include selecting a photo lab based on the determined location of the user and transmitting the photo file to a photo lab server associated with the selected photo lab. In some embodiments, the method may also generally include transmitting photographic printing information to the user, including an indication of the selected photo lab.

The disclosed embodiments provide an effective and efficient system of providing photographic printing to users on user devices. By providing photographic prints from a photo lab based on the location of the user, an improved method of providing photographic prints is disclosed. A user may save time and money when the disclosed method is compared to a user having to bring in photo files in person to a photo lab for printing and picking them up in person again at a later time when they are complete. Many users do not desire or cannot do photographic printing at home, and the disclosed embodiments allow these users to easily take advantage of the hardware and expertise of photo labs.

While specific embodiments will be described below with reference to particular configurations of hardware and/or software, those of skill in the art will realize that embodiments of the present invention may advantageously be implemented with other substantially equivalent hardware and/or software systems.

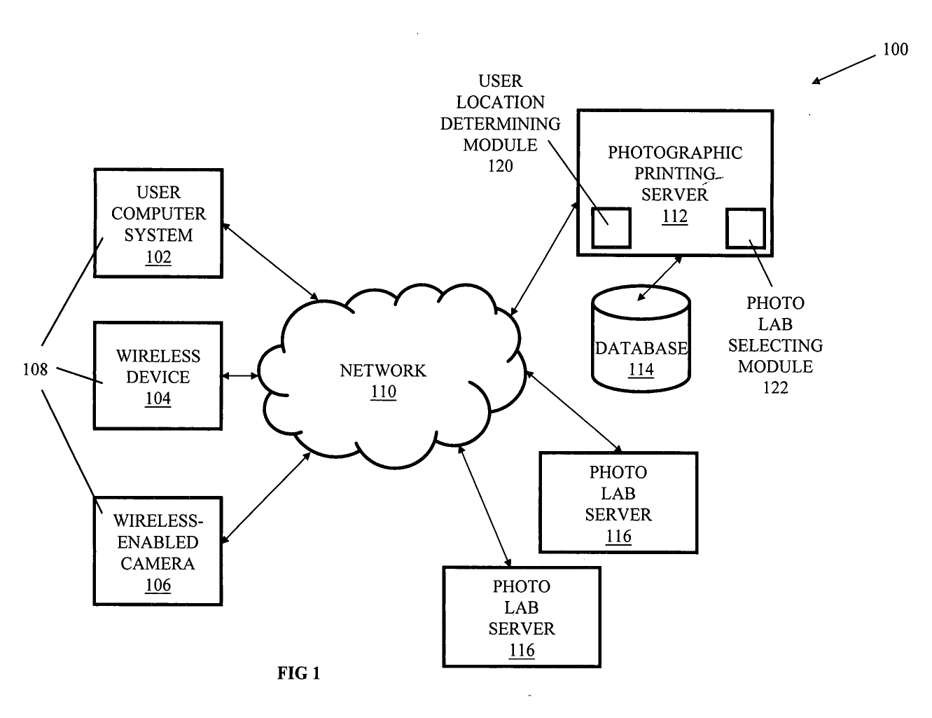

Turning now to the drawings, FIG. 1 depicts a photographic printing system 100 for providing photographic prints to users on user devices 108 according to one embodiment. In the depicted embodiment, network access system 100 includes a plurality of user devices 108 in communication with network 110. User devices 108 may include user computer systems 102, wireless devices 104, wireless-enabled cameras 106, or any other type of device. Photographic printing system 100 also includes a photographic printing server 112 and one or more photo lab servers 116 in communication with network 110 in the depicted embodiment. The photographic printing server 112 may be used to receiving photo files from users on user devices 108 and to selectively transmit the photo files to one of the photo lab servers 116 for eventual printing. Photographic printing system 100 may also include a database 114 for storing photo files, user information, information about photos that have been printed, etc.

In photographic printing system 100, the user devices 108, photographic printing server 112, database 114, and photo lab servers 116 may be located at the same location, such as in the same building or computer lab, or could be remote. While the term “remote” is used with reference to the distance between the components of photographic printing system 100, the term is used in the sense of indicating separation of some sort, rather than in the sense of indicating a large physical distance between the systems. For example, any of the components of photographic printing system 100 may be physically adjacent or located as part of the same computer system in some network arrangements.

User devices 108 may include any type of device that may capture, store or hold a photo file and that is adapted to communicate with network 110. User devices 108 may include user computer systems 102, wireless devices 104, or wireless-enabled cameras 106. User computer systems 102 may include one or more personal computers (PCs), workstations, servers, mainframe computers, notebook or laptop computers, tablet PCs, desktop computers, portable computer systems, personal digital assistants (PDAs), set-top boxes, or the like. Wireless devices 104 may include any type of device adapted to communicate with a wireless network 110, such as mobile phones, wireless-enabled PDAs or computer systems, etc. Wireless-enabled cameras 106 may include any type of camera or other image capture device (i.e., mobile phone with built-in digital camera) that is adapted to communicate with a network 110, such as a digital camera with wireless capability (e.g., Bluetooth-enabled digital camera, digital camera with built-in mobile or cellular phone, etc.).

Network 110 may be any type of data communications channel, such as the Internet, an intranet, a LAN, a wide area network (WAN), an Ethernet network, a wireless network, etc. In one example, network 110 may be the Internet in an embodiment where users are utilizing user computer systems 102 in their homes to transmit photo files to the photographic printing server 112. In another example, network 110 may be a wireless network in an embodiment where users are utilizing a wireless device 104 or wireless-enabled camera to transmit photo files to the photographic printing server 112. Multiple types of networks may also be used, such as the Internet for some communications and wireless networks for others. Those skilled in the art will recognize, however, that the invention described herein may be implemented utilizing any type(s) of data communications channel.

Photographic printing server 112 may include any type of processing device that receives photo files from user devices 108 and that transmits photo files to photographic lab servers 116 via one or more networks 110. Photographic printing server 112 may include one or more PCs, workstations, servers, mainframe computers, notebook or laptop computers, tablet PCs, desktop computers, portable computer systems, or the like.

Photographic printing system 100 may also include a database 114 for storing information relating to the photographic printing system 100, such as user preferences, photo files, user information, etc. Database 114 may be located anywhere within the photographic printing system 100, including as a standalone database, as part of the photographic printing server 112, etc., and may be stored on any type of storage device, such as hard drives, server farms, volatile memory, etc.

In the depicted embodiment, the photographic printing server 112 also includes a user location determining module 120 and a photo lab selecting module 122. The user location determining module 120 may be used to determine the location of the user from which the request or photo file is received. The user location determining module 120 may determine the location of the user based on the user information received from the user on the user device 108. In one embodiment, an indication of the location of the user is included in the information received from the user. For example, coordinates calculated using a location determining device (e.g., a Global Positioning System receiver) may be received from the user and the location of the user may then be determined. In another example, a user may select or otherwise input a location, such as from a pull-down menu, that is transmitted to the photographic printing server 112 and is used to determine the user's location.

In another embodiment, the location of the user may be determined by the user location determining module 120 based on the identity of the user. For example, the location of the user (i.e., User A is located in New York City) may be located in a database, such as database 114, so that the likely location of the user may be determined based on the identity of the user. In another example, the address of the user may be located in a database such as the database 114 and this address may be used as a proxy for the location of the user. In yet another example, a user may input user preferences specifying their location at a certain time (e.g., always determine location based on home address, during a particular week send to my vacation location, etc.). Any type of methodology may be used to determine the location of the user and users may, in one embodiment, choose the type of methodology used by the user location determining module 120.

The photo lab selecting module 122 may be used to select a photo lab for printing the user's photos based on the determined location of the user. In one embodiment, the photo lab selecting module 122 may select the photo lab closest to the determined location of the user. In a further embodiment, the closest photo lab from a list may be selected. The list of photo labs may be based on photo labs with the capability of printing photos based on user photo files, on photo labs associated with the photographic printing server 112, on photo labs selected as suitable by the user, on photo labs of a particular company, on photo labs that offer a particular range of prices, etc. The photo lab selecting module 122 may use more complicated methodologies to select a photo lab as well. For example, a photo lab may be chosen based on a combination of factors, such as cost, workload, proximity to the user's determined location, company, etc. In one example, a photo lab that was at full capacity or cost twice as much as a lab further away could be passed over in favor of more distant lab. Any type of methodology may be used by the photo lab selecting module 122, and users may, in one embodiment, choose the type of methodology used by the photo lab selecting module 122.

Photo lab servers 116 may include any type of processing device that receives photo files from a photographic printing server 112 via network 110. Photo lab servers 116 may include one or more PCs, workstations, servers, mainframe computers, notebook or laptop computers, tablet PCs, desktop computers, portable computer systems, or the like. In one embodiment, photo lab servers 116 are physically located at a photo lab or other location at which a photographic printer is used. For example, a photo lab may have an on-site photo lab server 116 that is in communication with one or more photographic printers that provide prints from digital files. Photographic printers that provide prints from digital files include inkjet printers such as Seiko Epson Corporation's Epson Stylus Pro series, silver-halide based systems such as Fuji Photo Film Corporation's Fuji Frontier Minilab Systems, or any other type of printer.

In photographic printing system 100, a user device 108 may transmit a photo file to the photographic printing server 112 via network 110. The photographic printing server 112 may then determine the location of the transmitting user device 108 and select a photo lab server 116 based on the determined user location using the user location determining module 120 and the photo lab selecting module 122, respectively. The photo file may then be transmitted from the photographic printing server 112 to the selected photo lab server 116 via network 110 for printing. The user may then go to the nearby photo lab to pick up their finished print. This method and system provides improved printing of photo files, as users need only make one trip to the photo lab to pick up prints and need not wait for prints to be mailed to them, a process that causes delays, additional costs, and the possibility of damage.

The photographic printing system 100 provides advantages for many types of users. In one example, a user on a user computer system 102 (such as a home computer) could transmit photo files to the photographic printing server 112. The photographic printing server 112 may then determine the user's location (i.e., at home) and select the nearest or otherwise most appropriate photo lab, transmitting the photo file to the appropriate photo lab server 116. The user would then only need to go to the selected photo lab to pick up their completed trips, saving a trip or the cost and risks of mailing.

In another example, a user on a wireless device 104 such as a wireless-enabled PDA may have a set of photo files stored on the wireless device 104. If this user desired to print out one of the photo files while they were away from home and using the wireless device 104, they could transmit the desired photo file to the photographic printing server 112 along with an indication of where they are located. In this example, a user could manually input or select a location that best represents their present location (e.g., in Austin). The photographic printing server 112 would then determine the user's location and select the appropriate photo lab for transmittal of the photo file. The user may then go to that photo lab to pick up their print while they are out, saving a significant amount of time and resources.

In yet another example, a user with a wireless-enabled camera 106 may take a picture that they desire to print immediately. In this example, the wireless-enabled camera 106 may also be equipped with a location determining device such as a Global Positioning System (GPS) receiver. The wireless-enabled camera 106 may transmit the location information and the photo file to the photographic printing server 112. The photographic printing server 112 would then use the location information to determine the user's location and to select a photo lab near the user. The user may then go to that photo lab to pick up their print without ever having to use their personal computer and while they are still out in the field. This may be particularly useful for a user on a multi-day photo shoot, as they could get easily have prints made during their shoot without having to return to their office or lab.

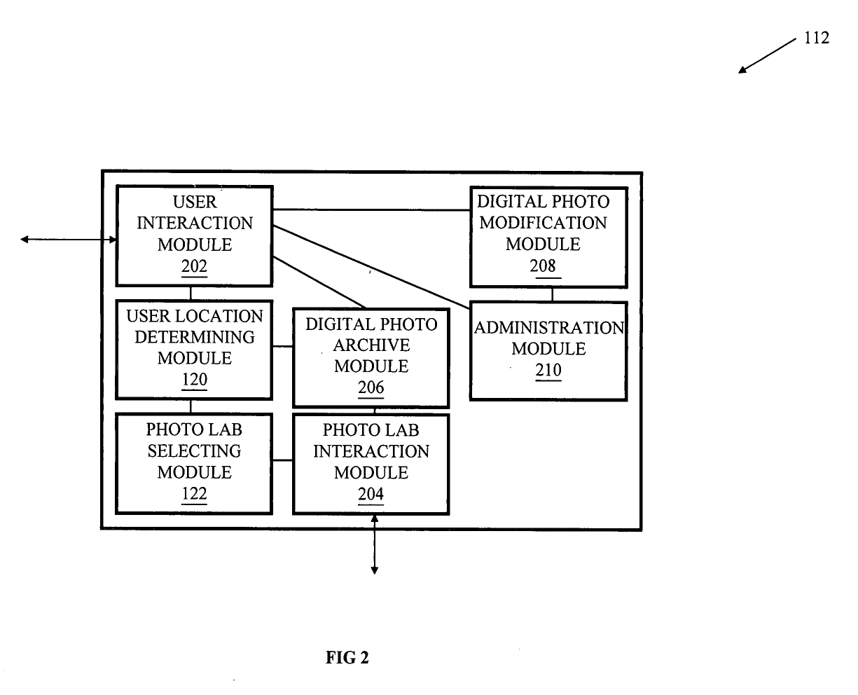

FIG. 2 depicts one embodiment of the photographic printing server 112 of FIG. 1. In the depicted embodiment, the photographic printing server 112 includes a user interaction module 202, a user location determining module 120, a photo lab selecting module 122, a photo lab interaction module 204, a digital photo archive module 206, a digital photo modification module 208, and an administration module 210. The user location determining module 120 and the photo lab selecting module 122 are described in detail in relation to FIG. 1 and will not be discussed here in the interest of brevity. The user interaction module 202 may be used to transmit communications to and receive communications from any of the user devices 108, such as via network 110. User preferences, photo files, billing information or other type of information may be received from users on user devices 108 using the user interaction module 202. Similarly, the identity or location of the selected photo lab, among other information, may be transmitted to the user on the user device 108 using the user interaction module 202.

The photo lab interaction module 204 may be used to transmit communications to and receive communications from any of the photo lab servers 116, such as the selected photo lab server 116, via network 110. The photo lab interaction module 204 may use a different network 110 than the user interaction module 202. The photo lab interaction module 204 may use, in one example, the Internet, while the user interaction module 202 may use a wireless network. User information, photo files or any other type of information may be transmitted to a photo lab server 116 using the photo lab interaction module 204. Similarly, information relating to printing of the user's photo file, such as billing information or notice of completion or receipt, or any other type of information may be received from the photo lab server 116 by the photo lab interaction module 204.

Optional digital photo archive module 206 may be used to store photo files received from users and passed to photo lab servers 116 for later use. The photo files may be stored on database 114 or other database. In one embodiment, photo files are saved indefinitely so that users can later request prints from their photo files without having to retransmit the photo files. This may be particularly useful when the photo files are large or when the user loses their copy of a photo file. In another embodiment, photo files may be saved until confirmation is received that a photo file has been received and/or printed by a photo lab with a photo lab server 116.

Optional digital photo modification module 208 may be used to modify photo files received from users before they are passed to a photo lab server 116 for eventual printing. Photo files may be modified in any way, such as being resized, cropped, enlarged, converted to a different file format, sharpened, etc. In one embodiment, automatic modification of photo files may be performed by the digital photo modification module 208, such as automatically resizing the photo file to optimize for a certain size of printers. Photo file modifications may be performed at the request of a user (e.g., user requesting sharpening before printing), based on the selected photo lab server 116 (e.g., resizing photo file based on available printers at the photo lab), etc.

Optional administration module 210 may be used to allow an administrator or other user to change configurations or settings of the photographic printing server 112. Configurations or settings that may be changed include the list of photo labs, types of transmissions to users, type of information transmitted to the photo lab server 116, photo file archiving settings, parameters for selecting photo labs, methodology for determining user locations, or any other type of configuration or setting.

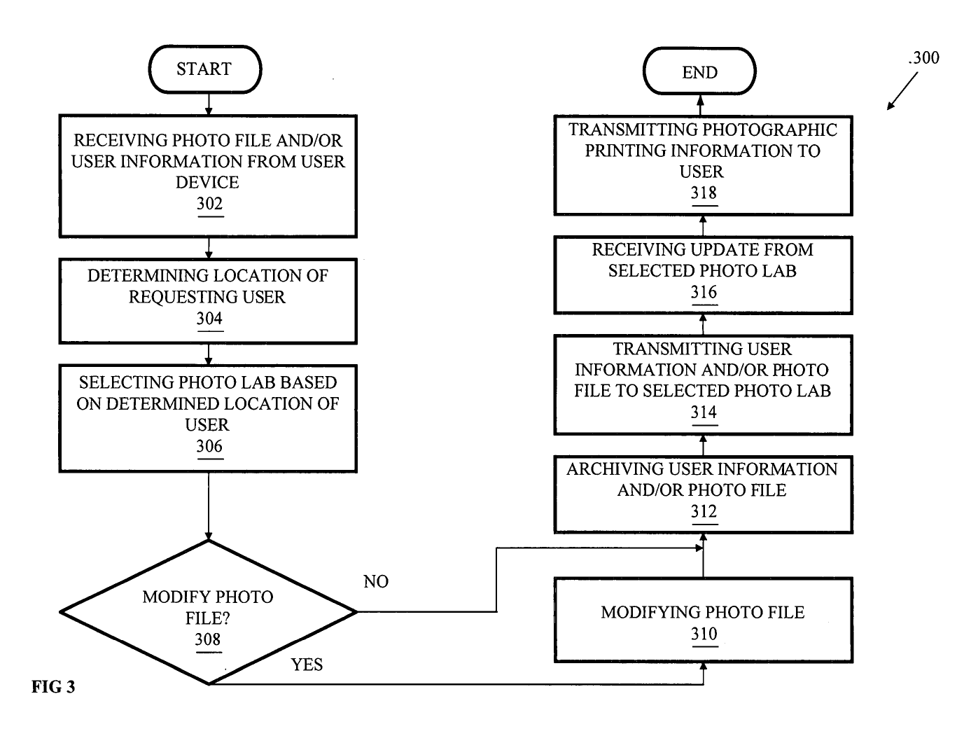

FIG. 3 depicts an example of a flow chart for receiving a photo file from a user and transmitting the photo file to a photo lab server 116 according to one embodiment. The method of flow chart 300 may be performed, in one embodiment, by the photographic printing server 112. Flow chart 300 begins with element 302, receiving a photo file and/or user information from a user on a user device 108. In this element, a photo file may be received from a user device 108 that the user desires to be printed at a nearby photo lab. User information, such as the user's name, address, e-mail address, printing requests, lab preferences, etc. may also be received in this element.

The method of flow chart 300 continues to element 304, determining the location of the requesting user. In this element, the location of the requesting user is determined based on the user information received in element 302. In one embodiment, the user information may contain an indication of the user's location. For example, the user information may contain information created by a location determining device on the user device 108, such as a GPS receiver, or by the user device 108 itself. In another example, the user information may contain an indication of the user's location provided by the user, such as something input by the user using the user device 108. In this example, a user may select a location via keyboard entry, pull down menu, or other user interface device, and the user's input may then be converted, if necessary to a format suitable for the photographic printing server 112. If a user selected ‘Austin’ as their location, element 602 may, in one embodiment, convert that user selection of a latitude and longitude for use by the photographic printing server 112.

Other methodologies for determining the location of the user are also possible. In one embodiment, a user's identity may be discerned from their photo file transmission or the user information, allowing the method of element 304 to reference a database (such as database 114) to determine a location for the user. This embodiment would allow, for example, a user to set up a default location for them, such as their home or place of business, so that print requests from them would be routed based on that location.

Flow chart 300 continues to element 306, selecting a photo lab based on the determined location of the user. In this element, a photo lab for printing the digital file may be selected based on a variety of factors, including the determined location of the user and the relative location of the photo labs. In one embodiment, the photo lab closest to the determined location of the user may be selected. In a further embodiment, the closest photo lab from a list may be selected. The list of photo labs may be based on photo labs with the capability of printing photos based on user photo files, on photo labs associated with the photographic printing server 112, on photo labs selected as suitable by the user, on photo labs of a particular company, on photo labs that offer a particular range of prices, etc. In another embodiment, more complicated methodologies may be used as well, such as by choosing a photo lab based on a combination of factors, such as cost, workload, proximity to the user's determined location, company, etc. Any type of methodology may be used to select a photo lab for printing.

Flow chart 300 continues to decision block 308, where it is determined if the photo file should be modified. Whether the photo file should be modified may be based upon user preference in one embodiment. In another embodiment, the determination of whether the photo file should be modified may be based on an analysis of the photo file, such as to determine if the photo file is the appropriate size for printing, color or black & white, etc. In yet another embodiment, all photo files may be modified, such as when information about the photographic printing server 112 or the user may be added to the photo file (e.g. in header information, etc.). If the photo file will not be modified, the flow chart continues to element 312, described below. If it is determined that the photo file will be modified, flow chart 300 continues to element 310, modifying photo file, before continuing to element 312.

In element 310, the photo file may be modified. In one embodiment, the content of the digital photograph within the photo file is modified, such as by color correction, cropping, conversion to black & white, resize, etc. In another embodiment, information may be added to the photo file. For example, user information may be added to the photo file so that the printing photo lab has the name, address, contact information, etc. of the user. In another embodiment, information about the transmitting photographic printing server 112 may be added, such as when the owner of the photographic printing server 112 receives a referral fee for transmitting the photo file to the lab. Printing instructions may also be added to the photo file in another example. Any type of information may be added or removed from the photo file, and any type of modification may be made.

In element 312, the photo file, user information, and/or any other information may be archived. In this element, the photo file and/or user information may be optionally archives to a database such as database 114. In one embodiment, photo files may be saved indefinitely so that users can later request prints from their photo files without having to retransmit the photo files. This may be particularly useful when the photo files are large or when the user loses their copy of a photo file. In another embodiment, photo files may be saved until confirmation is received that a photo file has been received and/or printed by a photo lab with a photo lab server 116. In another embodiment, user information may be archived so that a history of users using the photographic printing system 100 may be saved. In yet another embodiment, information about which photo lab server 116 the photo file was sent, printing information, etc. may be archived for billing or invoicing purposes.

Flow chart 300 continues to element 314, transmitting the photo file and/or user information to the select photo lab. In this element, the photo file, and optionally the user information or other information, may be transmitted to the photo lab server 116 associated with the selected photo lab. The transmission may occur using any format and any method, such as via network 110. When the photo lab receives the photo file on the photo lab server 116, a print may be made from the photo file pursuant to any instructions. Flow chart 300 then continues to optional element 316, where an update (e.g., notice that the print is completed, cost, estimated completion time, etc.) may be received from the selected photo lab or photo lab server 116. Flow chart 300 then continues to optional element 316, transmitting photographic printing information to the user. In this element, information about the printing may be sent to the user on the user device 108. For example, the location of the selected photo lab may be transmitted to the user so that they know where to pick up their print. In another example, a price or completion time may be transmitted to the user to provide them with additional information. Flow chart 300 then terminates.

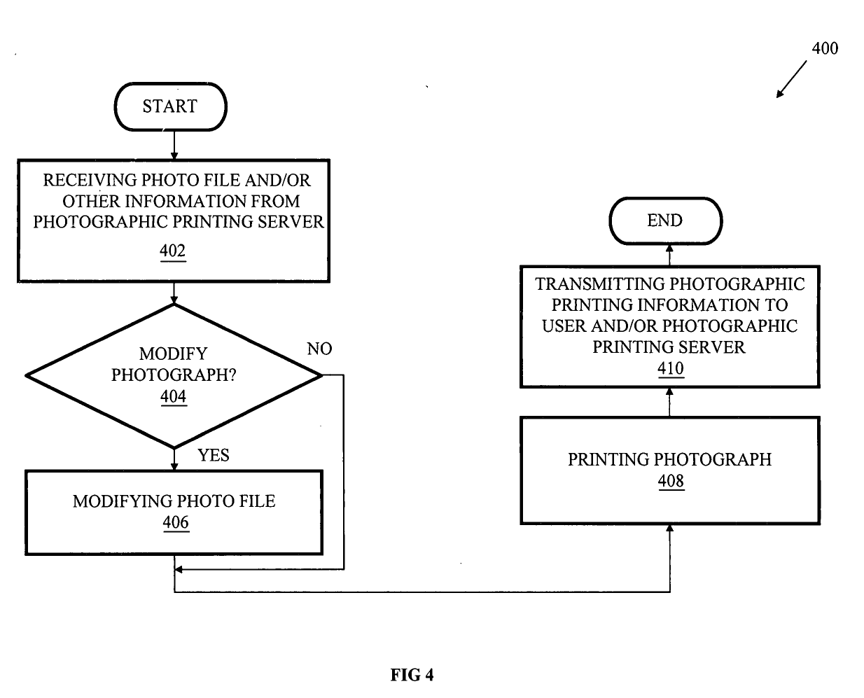

FIG. 4 depicts an example of a flow chart for a receiving a request for photographic printing and printing a photograph according to one embodiment. The method of flow chart 400 may be performed, in one embodiment, by the photo lab server 116. Flow chart 400 begins with element 402, receiving a photo file and/or other information, such as user information, from a photographic printing server 112. In this element, a photo file may be received at the photo lab server 116 associated with the selected photo lab for printing. Other information, such as the user's name, address, e-mail address, printing requests, lab preferences, etc., or other printing or billing instructions may also be received.

Flow chart 400 continues to decision block 404, where it is determined if the photo file should be modified. Whether the photo file should be modified may be based upon user preferences received from the photographic printing server 112 in one embodiment. In another embodiment, the determination of whether the photo file should be modified may be based on an analysis of the photo file, such as to determine if the photo file is the appropriate size for printing, color or black & white, needs to be cropped, etc. If the photo file will not be modified, the flow chart continues to element 408, described below. If it is determined that the photo file will be modified, flow chart 400 continues to element 406, modifying photo file, before continuing to element 408. In one embodiment of element 406, the content of the digital photograph within the photo file is modified, such as by color correction, cropping, conversion to black & white, resize, etc. Any type of modification may be made to the photo file.

In element 408, a photographic print may be made from the photo file (either as received or modified). In one embodiment, a photographic printer may make the print based on the photo file, but other alternatives are possible. The print may be made based on the instructions received from the user and/or photographic printing server 112, such as the size of the print, the type of paper, the type of finish (e.g., glossy, matte, etc.), etc. Flow chart 400 then continues to optional element 410, transmitting photographic printing information to the user and/or the photographic printing server 112, after which the flow chart terminates. In one embodiment of element 410, notification that the print has been made may be sent directly to the user on the user device 108, such as by e-mail. Other information may also be sent, such as directions to the photo lab, billing information, estimated time of completion, etc. In another embodiment, information about the printing (status, billing, etc.) may be sent to the photographic printing server 410, which may also forward information to the user on the user device 108.

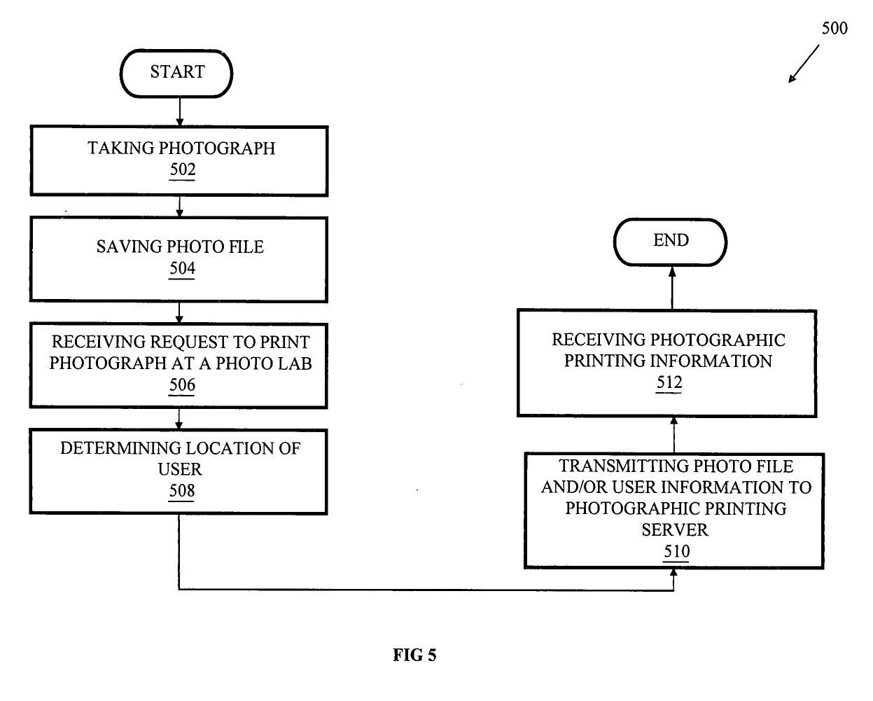

FIG. 5 depicts an example of a flow chart for transmitting a photo file for printing according to one embodiment. The method of flow chart 500 may be performed, in one embodiment, by the user and/or user device 108. Flow chart 500 begins with optional element 502, taking a photograph. In this element, the user device 108 may be used to take a digital image or photograph. This element is more suitable to be performed by a wireless-enabled camera 106 or a wireless device 104 equipped with a camera, such as a wireless phone with picture-taking capabilities. In element 504, the photo file created when the photograph was created may be saved. Alternatively, a photo file may be created or acquired via other means, such as by receiving the photo file from another source (e.g., e-mail, download), scanning film, etc. Any type of methodology to create or acquire a photo file may be utilized.

The method of flow chart 500 continues to element 506, receiving a request to print the photograph at a photo lab. In this element, the user device 108 may receive an indication from a user that the user desires for the photo file to be printed at a lab. The user may optionally specify preferences for the type of print, number of prints, preferred photo labs, specifications for the photo lab, etc. In an alternative embodiment, the request may be automatically generated upon the occurrence of a particular event, such as by automatically requesting a print for every photograph taken with user device 108.

The method of flow chart 500 continues to element 508, determining the location of the user. In one embodiment, the user device may have a location determining device such as a GPS receiver that may be used to determine the user's present location. In another embodiment, the location of the user may be determined based on user input, such as a location entered by the user on the user device 108 via keyboard entry, pull down menu, or other user interface device. In yet another embodiment, the location of the user is not determined and a default location for the user may be used, such as their home or business address.

Flow chart 500 then continues to element 510, transmitting the photo file, and possibly other information such as user information, to the photographic printing server 1.12. The transmission may occur in any way, including via network 110. In optional element 512, photographic printing information may be received from either the photographic printing server 112 or a photo lab server 116. Any photographic printing information that is received, such as status information or the location or identity of the selected photo lab, may be displayed to the user using the user device 108. After element 512, flow chart 500 terminates.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for providing photographic prints to a user. It is understood that the form of the invention shown and described in the detailed description and the drawings are to be taken merely as examples. It is intended that the following claims be interpreted broadly to embrace all the variations of the example embodiments disclosed.

What is claimed is:

1. A method for providing photographic prints to a user, the method comprising:
receiving a photo file and user information from a user on a user device;
determining the location of the user based on the received user information;
selecting a photo lab based on the determined location of the user; and
transmitting the photo file to a photo lab server associated with the selected photo lab.

2. The method of claim 1, further comprising modifying the photo file.

3. The method of claim 1, further comprising archiving the photo file.

4. The method of claim 1, further comprising transmitting photographic printing information to the user, the photographic printing information comprising an indication of the selected photo lab.

5. The method of claim 1, further comprising transmitting user information to the photo lab server associated with the selected photo lab.

6. The method of claim 1, wherein receiving the user information from the user on the user device comprises receiving an identification of the user from the user on the user device.

7. The method of claim 1, wherein receiving the user information from the user on the user device comprises receiving an indication of the location of the user from the user on the user device.

8. The method of claim 1, wherein receiving the user information from the user on the user device comprises receiving an indication of user preferences for a photo lab from the user on the user device.

9. The method of claim 1, wherein receiving the user information from the user on the user device comprises receiving an indication of the number and type of prints desired by the user from the user on the user device.

10. The method of claim 1, wherein determining the location of the user based on the received user information comprises determining the location of the user based on the user's address.

11. The method of claim 1, wherein determining the location of the user based on the received user information comprises determining the location of the user based on information generated by a location determining system.

12. The method of claim 1, wherein determining the location of the user based on the received user information comprises determining the location of the user based on information generated by a Global Positioning System (GPS) receiver.

13. The method of claim 1, wherein determining the location of the user based on the received user information comprises determining the location of the user based on user input to the user device.

14. The method of claim 1, wherein selecting the photo lab based on the determined location of the user comprises selecting the photo lab closest to the determined location of the user.

15. The method of claim 1, wherein selecting the photo lab based on the determined location of the user comprises selecting the photo lab from a list of photo labs.

16. The method of claim 1, wherein selecting the photo lab based on the determined location of the user comprises selecting the photo lab closest to the determined location of the user from a list of photo labs.

17. A machine-accessible medium containing instructions effective, when executing in a data processing system, to cause said data processing system to perform operations comprising:
receiving a photo file and user information from a user on a user device;
determining the location of the user based on the received user information;
selecting a photo lab based on the determined location of the user; and
transmitting the photo file to a photo lab server associated with the selected photo lab.

18. The machine-accessible medium of claim 17, further comprising modifying the photo file.

19. The machine-accessible medium of claim 17, further comprising archiving the photo file.

20. The machine-accessible medium of claim 17, further comprising transmitting photographic printing information to the user, the photographic printing information comprising an indication of the selected photo lab.

21. The machine-accessible medium of claim 17, further comprising transmitting user information to the photo lab server associated with the selected photo lab.

22. A data processing system for providing photographic printing to a user, the system comprising:
a user interaction module, the user interaction module being adapted to receive a photo file and user information from the user via a network;
a user location determining module in communication with the user interaction module, the user location determining module being adapted to determine a location for the user based on the received user information;
a photo lab selecting module in communication with the user location determining module, the photo lab selecting module being adapted to select a photo lab based on the determined location of the user; and
a photo lab interaction module in communication with the photo lab selecting module, the photo lab interaction module being adapted to transmit the photo file to a photo lab server associated with the selected photo lab.

23. The system of claim 22, further comprising a digital photo archive module, the digital photo archive module being adapted to archive a copy of the photo file.

24. The system of claim 22, further comprising a digital photo modification module, the digital photo archive module being adapted to modify the photo file.

25. The system of claim 22, wherein the user information comprises an indication of the location of the user.

26. The system of claim 22, wherein the user information comprises an indication of the address of the user.

27. The system of claim 22, wherein the photo lab selecting module is adapted to select the photo lab closest to the determined location of the user.

28. The system of claim 22, wherein the photo lab selecting module is adapted to select the photo lab from a list of photo labs.
